(19) United States
(12) Patent Application Publication
(10) Pub. No.: US 2010/0303479 A1
(43) Pub. Date: Dec. 2, 2010

(54) IMAGE FORMING APPARATUS AND METHOD OF CONTROLLING AGITATING MEMBER

(75) Inventors: Shinichi ITOH, Kanagawa-ken (JP); Norio KOUZU, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/789,324

(22) Filed: May 27, 2010

Related U.S. Application Data
(60) Provisional application No. 61/181,978, filed on May 28, 2009.
(60) Provisional application No. 61/183,423, filed on Jun. 2, 2009.

(51) Int. Cl. G03G 21/12

(52) U.S. Cl. 399/21; 399/360

(57) ABSTRACT

An image forming apparatus includes: a rotating member to heat a toner on a sheet; a heater to heat the rotating member; a power controller to maintain temperature of the rotating member in a first mode after the temperature reaches the target temperature, and configured to raise the temperature to the target temperature in a second mode after the temperature falls under the target temperature; a waste toner container to store a waste toner; an agitator to agitate the waste toner in the waste toner container; an driver to rotate the agitator a number of times in a drive if the heat controller stops to raise the temperature in the second mode; a counter to count a number of the drives; and an agitation controller to set the number of times in the drive based on the number of the drives.

### CROSS-REFERENCE TO RELATED APPLICATION

This application is based upon and claims the benefit of priority from: U.S. provisional application 61/181,978, filed on May 28, 2009; and U.S. provisional application 61/183,423, filed on Jun. 2, 2009, the entire contents of each of which are incorporated herein by reference.

### FIELD

This specification relates to an image forming apparatus and a method of controlling an agitator.

### BACKGROUND

In the past, in driving control for an agitator configured to agitate a waste toner, when an image forming apparatus returns from a power saving mode or when a cover of the image forming apparatus is switched from an open state to a closed state, the agitator rotates a predetermined number of times.

However, in the driving control, in some case, the agitator unnecessarily rotates. When the agitator unnecessarily rotates, a waste of electric power occurs.

### DESCRIPTION OF THE DRAWINGS

FIG. 1 is a schematic diagram of an image forming apparatus according to a first embodiment;

FIG. 2 is a diagram of an example of a waste toner container;

FIG. 3 is a diagram of a positional relation between the waste toner container and a toner sensor;

FIG. 4 is a diagram of the positional relation between the waste toner container and the toner sensor;

FIG. 5 is a diagram of an example of a paddle;

FIG. 6 is a block diagram of components related to driving control for the paddle;

FIG. 7 is a flowchart for explaining a method of driving a paddle motor;

FIG. 8 is a block diagram of components related to driving control for a paddle in a second embodiment;

FIG. 9 is a flowchart for explaining a method of driving a paddle motor in the second embodiment;

FIG. 10 is a sectional view in a longitudinal direction of a first waste-toner carrying unit; and

FIG. 11 is a schematic diagram of a cleaner and a photoconductive drum.

### DETAILED DESCRIPTION

In general, an embodiment described herein relates to an image forming apparatus including a rotating member to heat a toner on a sheet; a heater to heat the rotating member; a power controller to maintain temperature of the rotating member in a first mode after the temperature reaches the target temperature, and configured to raise the temperature to the target temperature in a second mode after the temperature falls under the target temperature; a waste toner container to store a waste toner; an agitator to agitate the waste toner in the waste toner container; an driver to rotate the agitator a number of times in a drive if the heat controller stops to raise the temperature in the second mode; a counter to count a number of the drives; and an agitation controller to set the number of times in the drive based on the number of the drives.

The embodiment further relates to a method of controlling an agitator, including: maintaining temperature of a rotating member in a first mode after the temperature reaches a target temperature; forming a toner image on a sheet; discharging a waste toner to a waste toner container; heating a rotating member to heat the toner image on the sheet; raising the temperature to the target temperature in a second mode after the temperature falls under the target temperature; rotating an agitator in the waste toner container a number of times in a drive upon interruption of the raising; counting a number of the drives; and setting the number of times in a following drive based on the number of the drives.

Examples of embodiments are explained in detail below with reference to the accompanying drawings.

### First Embodiment

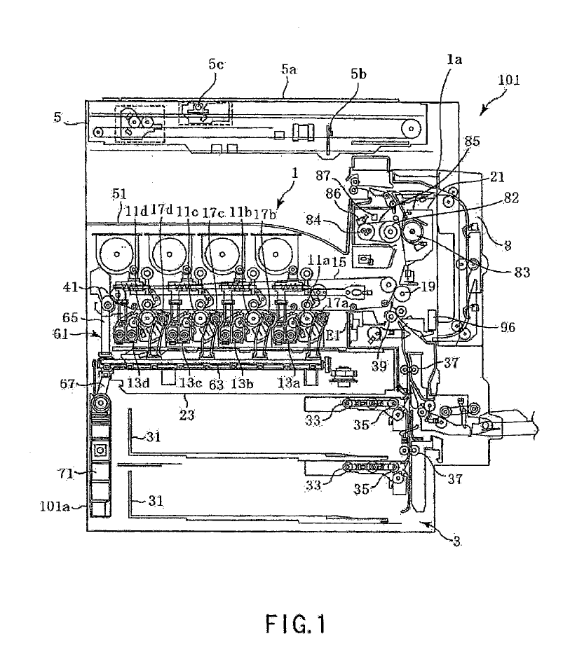

FIG. 1 is a schematic diagram of an image forming apparatus according to a first embodiment. An image forming apparatus 101 shown in FIG. 1 includes an image forming unit main body 1, a sheet feeding unit 3, and an image reading unit 5.

The image forming unit main body 1 includes photoconductive drums 11a to 11d, developing devices 13a to 13d, a transfer belt 15, cleaners 17a to 17d, a transfer device 19, and an exposing device 23. The photoconductive drums 11a to 11d hold latent images. The developing devices 13a to 13d supply toners to the latent images held by the photoconductive drums 11a to 11d corresponding the developing devices 13a to 13d and develop the latent images. The transfer belt 15 holds, in order, images of the toners held by the photoconductive drums 11a to 11d.

The cleaners 17a to 17d remove the toners remaining on the photoconductive drums 11a to 11d corresponding to the cleaners 17a to 17d. The transfer device 19 transfers the images of the toners held by the transfer belt 15 onto a sheet member. The sheet member may be plain paper or an OHP sheet as a transparent resin sheet.

The exposing device 23 forms latent images on the photoconductive drums 11a to 11d. A fixing device 21 fixes images of toners corresponding to image information on the sheet member and sends the sheet member to a stock unit 51 located in a space between the image reading unit 5 and the image forming unit main body 1.

The fixing device 21 includes a heating roller 82, a pressing roller 83, a stretching and suspending roller 84, a heating belt 85 as a rotating member, a heating unit 86, and a temperature detecting unit 87. The pressing roller 83 is rotated by a driving motor. The heating roller 82, the stretching and suspending roller 84, and the heating belt 85 rotate following the pressing roller 83.

The heating unit 86 induction-heats the heating belt 85 and heats the heating belt 85 to temperature suitable for fixing. The temperature suitable for the fixing by the heating belt 85 is referred to as target fixing temperature. The heating unit 86 includes a coil. A magnetic flux generated by high-frequency current applied to the coil induces eddy-current in the heating belt 85, whereby the heating belt 85 generates heat. The temperature detecting unit 87 acquires temperature information of the heating belt 85. The temperature detecting unit 87 may be a non-contact temperature sensor. The non-contact temperature sensor may be a temperature sensor of a thermopile type.

A belt surface of the transfer belt 15 moves while holding a toner remaining on the transfer belt 15. A belt cleaner 41 set in contact with the transfer belt 15 removes the waste toner held by the belt Surface of the transfer belt 15 from the transfer belt 15.

The sheet feeding unit 3 feeds, to the transfer device 19, a sheet member that the transfer device 19 uses in transferring the images of the toners. Cassettes, which are not explained in detail, located in plural cassette slots 31 store sheet members of arbitrary sizes. Pickup rollers 33 extract the sheet members from the cassettes corresponding to the pickup rollers 33 according to image forming operation not explained in detail. The sizes of the sheet members correspond to the sizes of images of toners formed by the image forming unit main body 1.

Separating mechanisms 35 separate the sheet members extracted from the cassettes by the pickup rollers 33 and prevent two or more sheet members from being conveyed at a time. Plural conveying rollers 37 convey one sheet member separated by the separating mechanisms 35 to an aligning roller 39.

The aligning roller 39 conveys, according to timing when the transfer device 19 transfers the images of the toners from the transfer belt 15, the sheet member to a transfer position where the transfer device 19 and the transfer belt 15 are set in contact with each other.

The image reading unit 5 includes a document table 5a configured to support an original document and an image sensor 5b configured to convert image information into image data. The image sensor 5b may be a CCD sensor. The image reading unit 5 converts reflected light, which is obtained by irradiating illumination light from an illuminating device 5c on the original document set on the document table 5a, into an image signal with the image sensor 5b.

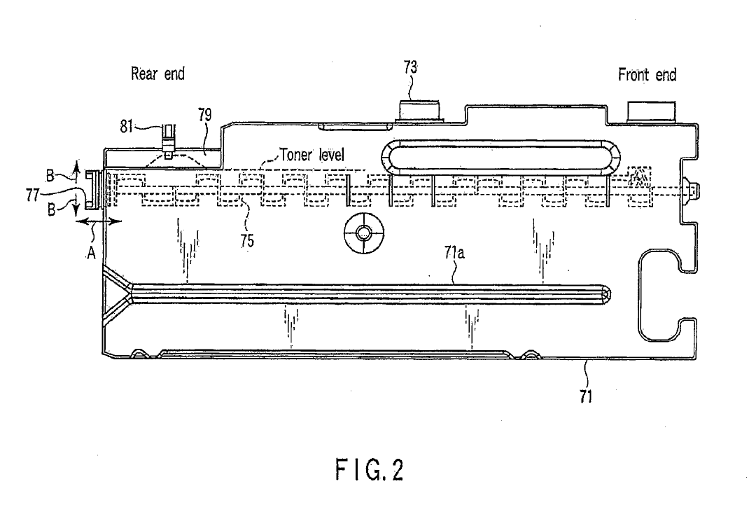

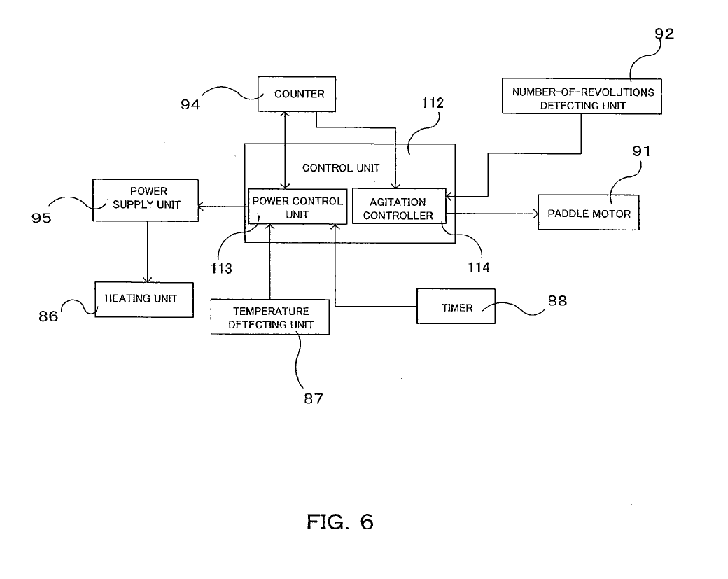

A waste toner container 71 is located between the slots 31 and a frame steel body 101a of the image forming apparatus 101 on a side of the slots 31. FIG. 2 is a diagram of an example of the waste toner container 71. The waste toner container 71 includes a paddle 75 as an agitator configured to agitate a waste toner in the waste toner container 71 and collect a part of the waste toner in one place. The paddle 75 has, at one end in a longitudinal direction of the waste toner container 71, a coupling 77 configured to receive rotating force from the outside. The coupling 77 is connected to a paddle motor 91 as a driver shown in FIG. 6 and rotated by driving force of the paddle motor 91. The paddle motor 91 is located on the rear side of the image forming apparatus 101.

The coupling 77 has slack in an axis direction indicated by an arrow A for easy coupling with a shaft of the paddle motor 91. The coupling 77 has slack in a direction orthogonal to an axis indicated by an arrow B for easy coupling with the shaft of the paddle motor 91. The waste toner container 71 includes a guide section 71a configured to guide movement from the front side of the image forming apparatus 101. The guide section 71a may be a rib or a groove.

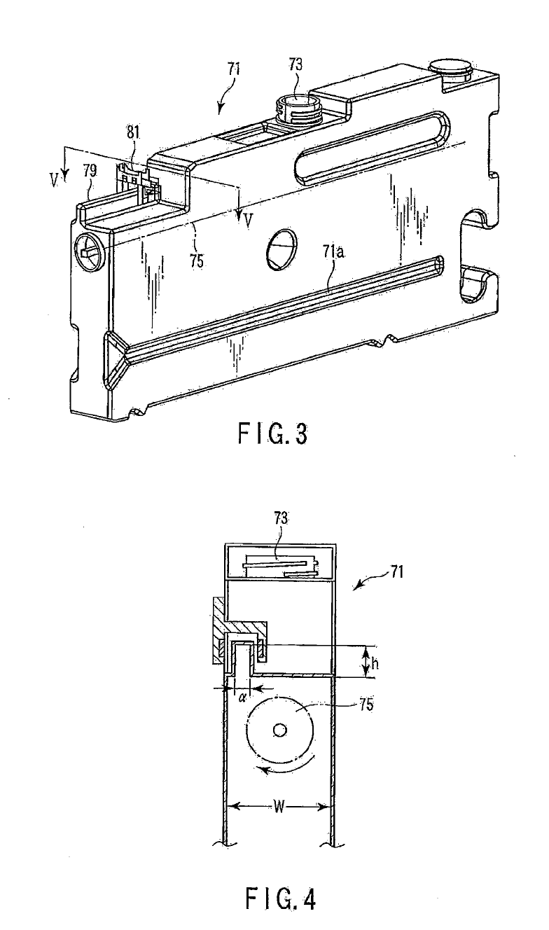

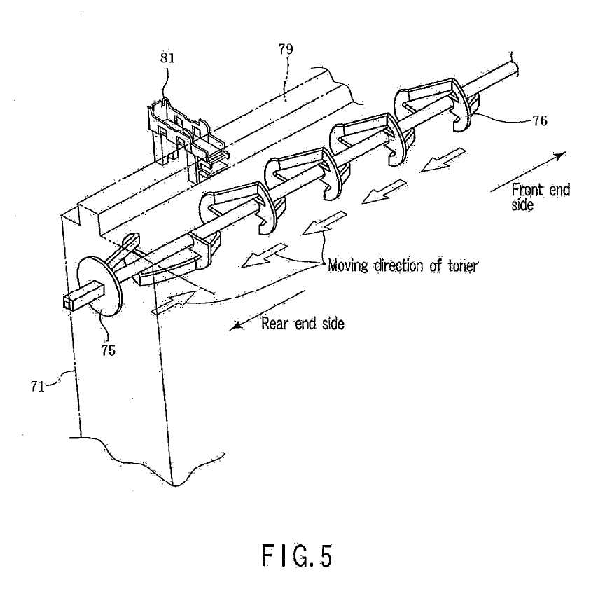

FIGS. 3 and 4 are diagrams of a positional relation between the waste toner container 71 and a toner sensor 81. The waste toner container 71 has a full detection area 79 as an acquisition area for allowing the toner sensor 81 to detect a level of the waste toner when the waste toner container 71 is filled with the waste toner. The full detection area 79 is a space located, for example, a distance equal to or larger than 20 mm and equal to or smaller than 30 mm above the outer circumference of a rotation circle of the paddle 75 of the waste toner container 71 and having small width d compared with width W of the waste toner container 71. d/W may be about ⅓ to ⅕. Depth h may be the same as the width d or may be a distance equivalent to, for example, the distance equal to or larger than 20 mm and equal to or smaller than 30 mm above the outer circumference of the rotation circuit of the paddle 75. The waste toner container 71 may have length of 200 mm to 300 mm in the up to down direction, length of 400 mm to 500 mm in the front to rear direction, and length of 40 mm in the left to right direction.

The full detection area 79 allows the toner sensor 81 to continuously detect, for a fixed time, presence of the waste toner deposited in the waste toner container 71. The full detection area 79 is located closer to the back of the image forming apparatus 101.

The toner sensor 81 detects, in a position on the outer side of the waste toner container 71, that the waste toner is filled in the waste toner container 71. The toner sensor 81 may be an optical sensor including a light sending unit and a light receiving unit located to be opposed to the light sending unit or may be a sensor of a system for detecting electrostatic capacitance.

The toner sensor 81 is located in a position where the waste toner container 71 can be inserted from the front side of the image forming apparatus 101. The toner sensor 81 allows the waste toner container 71 to move to the front side of the image forming apparatus 101. The full detection area 79 is located in a position where the waste toner container 71 can be inserted from the front side of the image forming apparatus 101 without obstructing the toner sensor 81 from operating.

FIG. 5 is a diagram of an example of the paddle.

The paddle 75 has plural blade members 76 configured to provide carrying force for carrying the waste toner. A blade member closest to the back among the blade members 76 has a shape for carrying the waste toner to the front side of the image forming apparatus 101. The remaining blade members have a shape for carrying the waste toner to the rear side of the image forming apparatus 101.

The paddle 75 increases the density of the waste toner corresponding to the position where the toner sensor 81 detects the waste toner. The paddle 75 increases deposit height of the waste toner corresponding to the position where the toner sensor 81 detects the waste toner. The axis of the paddle 75 is offset from the center in the width direction of the full detection area 79. An opening of the full detection area 79 is opposed to a rotating direction of the paddle 75. Specifically, the paddle 75 carries the waste toner to obtain waste toner distribution suitable for the toner sensor 81 to detect the waste toner. The waste toner distribution suitable for the toner sensor 81 to detect the waste toner is referred to as proper waste toner distribution. When the paddle 75 unnecessarily rotates, the proper waste toner distribution is disarranged. Therefore, an agitation controller 114 controls the driving of the paddle motor 91 configured to rotate the paddle 75.

FIG. 6 is a block diagram of components related to the driving control for the paddle 75.

A control unit 112 manages control of the entire image forming apparatus 101. The control unit 112 includes a power control unit 113 and the agitation controller 114. A number-of-revolutions detecting unit 92 acquires the number of revolutions of the paddle motor 91. The number-of-revolutions detecting unit 92 may be a photointerrupter or a pulse motor. The photointerrupter acquires the number of revolutions of the paddle motor 91 by counting the number of times a flag provided on the shaft of the paddle motor 91 cuts the photointerrupter. When the paddle motor 91 is a pulse motor, the number-of-revolutions detecting unit 92 may be omitted. The agitation controller 114 may acquire the number of revolutions of the paddle motor 91 by counting a pulse signal for instructing the pulse motor to perform driving. The agitation controller 114 controls the driving of the paddle motor 91 on the basis of a detection result of the number-of-revolutions detecting unit 92.

The power control unit 113 controls, on the basis of a detection result of the temperature detecting unit 87, ON and OFF of a power supply unit 95 as a power controller configured to supply electric power to the heating unit 86. As a first mode, the power control unit 113 alternately switches ON and OFF of the power supply unit 95 such that the temperature of the heating belt 85 is maintained near target fixing temperature when the temperature of the heating belt 85 once reaches the target fixing temperature, i.e., the image forming apparatus 101 shifts to a READY state.

The power control unit 113 switches a power supply level of the power supply unit 95 among plural power levels including a use level and a sleep mode level. The use level may be a power level of the power supply unit 95 necessary for actuating the heating unit 86. The sleep mode level may be a power level of the power supply unit 95 necessary for the control unit 112 to operate, although lower than the use level.

When, according to a count result of a timer 88, the image forming apparatus 101 shifted to the READY state does not operate for a standby time T1, the power control unit 113 lowers the power supply level of the power supply unit 95 from the use level to the sleep mode level. The standby time T1 may be a predetermined design value.

In the sleep mode level, the power control unit 113 stops the supply of electric power from the power supply unit 95 to the heating unit 86. When the heating unit 86 stops, the temperature of the heating belt 85 falls. When a job is input in a state in which the heating unit 86 is stopped, the power control unit 113 raises the power supply level of the power supply unit 95 from the sleep mode level to the use level. When the power supply level is raised to the use level, the image forming apparatus 101 starts warming-up operation. In the warming-up operation, the power control unit 113 controls the power supply unit 95 such that the fallen temperature of the heating belt 85 reaches the target fixing temperature.

Specifically, as a second mode, the power control unit 113 prohibits, when the image forming apparatus 101 shifts to a sleep mode, the supply of electric power from the power supply unit 95 to the heating unit 86 and allows, when the image forming apparatus 101 shifts from the sleep mode to the warming-up operation, the supply of electric power from the power supply unit 95 to the heating unit 86.

The power control unit 113 counts the number of times the image forming apparatus 101 shifts to the sleep mode after electric power is supplied by the power supply unit 95. The power control unit 113 counts up a counter 94 on the basis of a result of the counting.

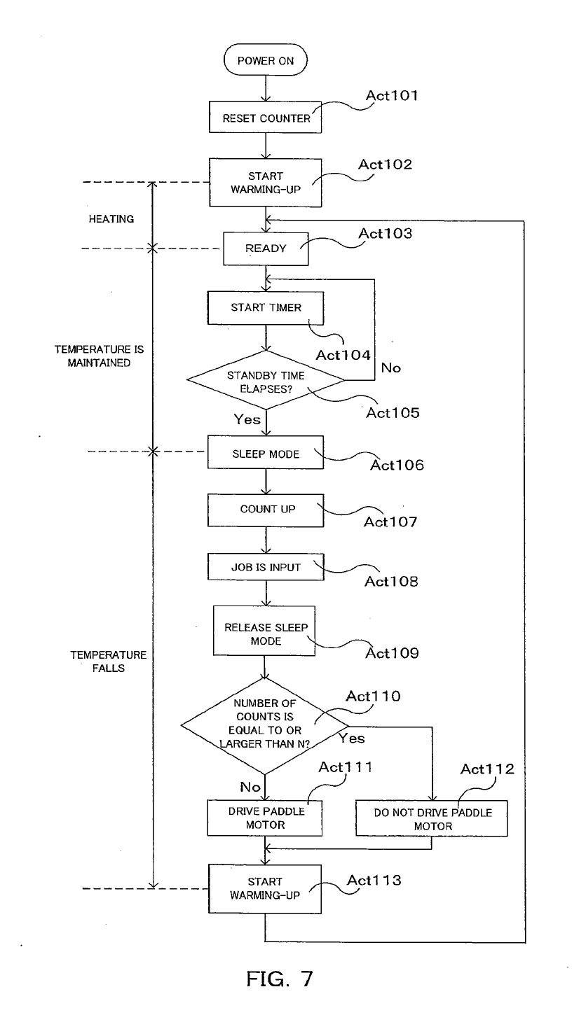

FIG. 7 is a flowchart for explaining a method of driving the paddle motor 91. When the power supply unit 95 is turned on, in Act 101, the power control unit 113 resets the number of counts of the counter 94. In Act 102, the control unit 112 instructs the entire image forming apparatus 101 to perform the warming-up operation. In the warming-up operation, the power control unit 113 allows the supply of electric power from the power supply unit 95 to the heating unit 86 and heats the heating belt 85. In Act 103, when the temperature of the heating belt 85 reaches the target fixing temperature, the image forming apparatus 101 shifts to the READY state.

In Act 104, the power control unit 113 starts the timer 88. In Act 105, the power control unit 113 determines whether count time of the timer 88 reaches the standby time T1.

If the count time of the timer 88 reaches the standby time T1, in Act 106, the power control unit 113 lowers the power supply level of the power supply unit 95 from the use level to the sleep mode level. When the image forming apparatus 101 shifts to the sleep mode, in Act 107, the power control unit 113 counts up the counter 94.

When a job is input in Act 108, in Act 109, the power control unit 113 releases the sleep mode of the image forming apparatus 101.

In Act 110, the power control unit 113 reads out the number of counts of the counter 94 and determines whether the number of counts is equal to or larger than N. If the number of counts of the counter 94 is smaller than N, in Act 111, the agitation controller 114 controls the paddle motor 91 to rotate X times. N may be a design value and may be an integer equal to or larger than 1. X may be a design value. If the number of counts of the counter 94 is equal to or larger than N, in Act 112, the agitation controller 114 does not drive the paddle motor 91. The agitation controller 114 maintains the distribution of a toner stored in the waste toner container 71 at the proper waste toner distribution by prohibiting the paddle motor 91 from unnecessarily rotating. Since the number of revolutions of the paddle motor 91 decreases, power saving and noise reduction of the image forming apparatus 101 are realized.

In Act 113, the control unit 112 instructs the entire image forming apparatus 101 to perform the warming-up operation.

### Modification of the First Embodiment

Referring to the flowchart shown in FIG. 7, in Act 112, the agitation controller 114 may control the paddle motor 91 to rotate Y times smaller than X times. Y is an integer equal to or larger than 1.

### Second Embodiment

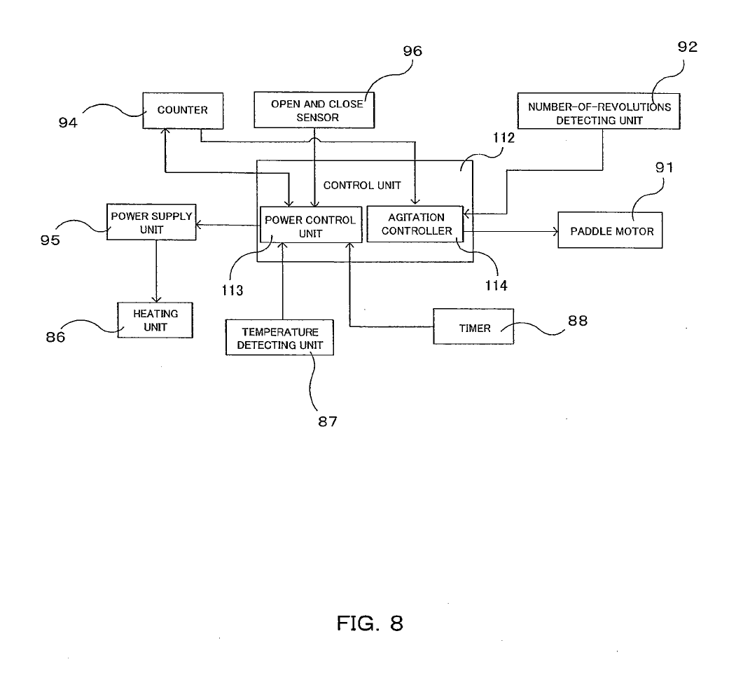

FIG. 8 is a block diagram of components related to driving control for the paddle 75. Components having functions same as those in the first embodiment are denoted by the same reference numerals and signs and detailed explanation of the components is omitted. The agitation controller 114 controls the driving of the paddle 75 on the basis of the number of times of opening and closing of a cover 8.

Referring to FIG. 1, the cover 8 operates between a closed position for closing an opening 1a of the image forming apparatus 101 and an open position for allowing a user to open the opening 1a to remove a sheet jam.

An open and close sensor 96 may have a switch of a push button type. When the cover 8 moves from the open position to the closed position and the switch is pressed, the open and close sensor 96 outputs a signal. The power control unit 113 discriminates open and close of the cover 8 on the basis of the signal output by the open and close sensor 96 and switches, on the basis of a result of the discrimination, the power supply level of the power supply unit 95 between the use level and the sleep mode level.

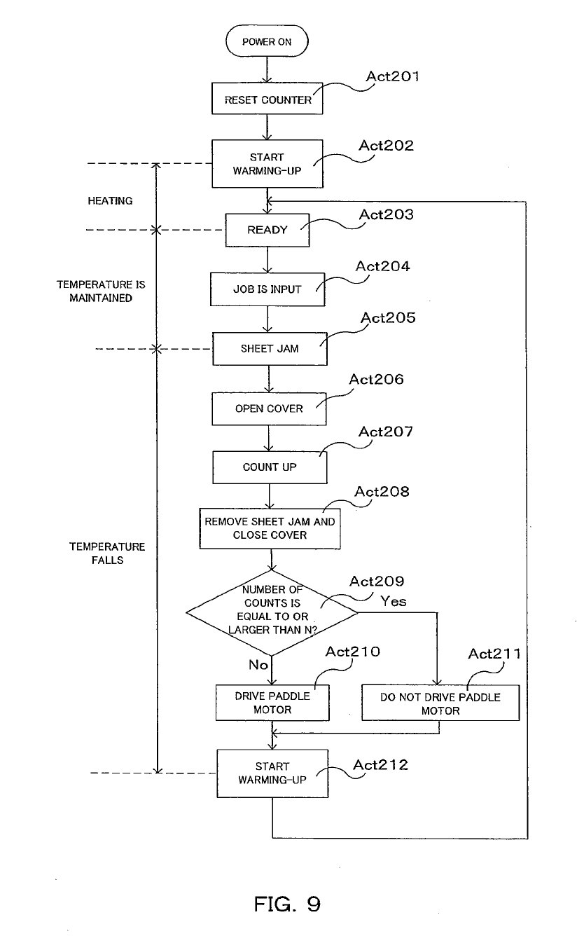

FIG. 9 is a flowchart for explaining a method of driving the paddle motor 91. When the power supply unit 95 is turned on, in Act 201, the power control unit 113 resets the number of counts of the counter 94. In Act 202, the control unit 112 instructs the entire image forming apparatus 101 to perform the warming-up operation. In Act 203, when the temperature of the heating belt 85 reaches the target fixing temperature, the image forming apparatus 101 shifts to the READY state.

When a job is input in Act 204 and a sheet jam occurs in Act 205, the power control unit 113 stops the supply of electric power from the power supply unit 95 to the heating unit 86.

When the power control unit 113 detects that the cover 8 opens in Act 206, in Act 207, the power control unit 113 counts up the counter 94. In Act 208, when a user removes the sheet jam and the power control unit 113 detects that the cover 8 closes, the power control unit 113 proceeds to Act 209. In Act 209, the agitation controller 114 reads out the number of counts of the counter 94 and determines whether the number of counts is equal to or larger than N. If the number of counts of the counter 94 is smaller than N, in Act 210, the agitation controller 114 controls the paddle motor 91 to rotate X times. N may be a design value and may be an integer equal to or larger than 1. X may be a design value.

If the number of counts of the counter 94 is equal to or larger than N, in Act 211, the agitation controller 114 does not drive the paddle motor 91. The agitation controller 114 maintains the distribution of a toner stored in the waste toner container 71 at the proper waste toner distribution suitable for full detection by prohibiting the paddle motor 91 from unnecessarily rotating. Since the number of revolutions of the paddle motor 91 decreases, power saving and noise reduction of the image forming apparatus 101 are realized.

The present invention can be carried out in various other forms without departing from the spirit and the main characteristics thereof. Therefore, the embodiments are merely exemplars in every aspect and should not be limitedly interpreted. The scope of the present invention is indicated by claims and is by no means restricted by the text of the specification. Further, all modification and various improvements, substitutions, and alterations belonging to the scope of equivalents of claims are within the scope of the present invention.

### Reference Examples

Reference examples are explained below.

Referring to FIG. 1, a waste-toner carrying mechanism 61 carries the waste toners removed from the photoconductive drums 11a to 11d by the cleaners 17a to 17d and the waste toner removed by the belt cleaner 41 to the waste toner container 71. The waste-toner carrying mechanism 61 includes a first waste-toner carrying unit 63 configured to carry the waste toners removed by the cleaners 17a to 17d to the waste toner container 71 and a second waste-toner carrying unit 65 configured to carry the waste toner removed by the belt cleaner 41 to the waste toner container 71.

A relay carrying unit 67 is located between the waste toner container 71 and the first and second waste-toner carrying units 63 and 65. The relay carrying unit 67 connects the first and second waste-toner carrying units 63 and 65 to a storage port 73 generally in the center in the longitudinal direction of the waste toner container 71.

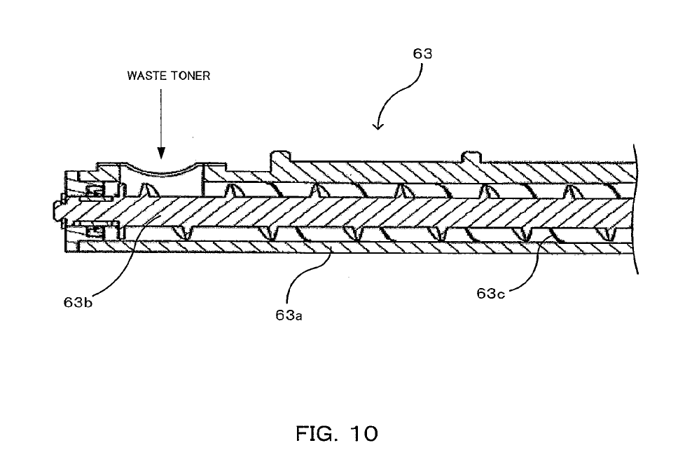

FIG. 10 is a partial sectional view including a longitudinal direction of the first waste-toner carrying unit 63. A first carrying tube 63a is connected to the relay carrying unit 67 and forms a carrying path for a waste toner. A carrying auger 63b is located on the inner side in the radial direction of the first carrying tube 63a. The carrying auger 63b includes a spiral blade section on the outer circumferential surface thereof. The carrying auger 63b rotates, whereby the waste toner moves to the relay carrying unit 67 through the first carrying tube 63a.

The carrying auger 63b includes a linear member 63c set in contact with the inner circumferential surface of the first carrying tube 63a. The linear member 63c is formed in a spiral shape having a rotation axis of the carrying auger 63b as a center axis. The linear member 63c projects further to the outer side in the radial direction of the carrying auger 63b than the blade section. One end of the linear member 63c is fixed to one end of the carrying auger 63b. The other end of the linear member 63c is fixed to the other end of the carrying auger 63b. The linear member 63c may be a SUS member.

When the carrying auger 63b rotates, the linear member 63c rotates while being set in contact with the inner surface of the first carrying tube 63a. The waste toner adhering to the inner surface of the first carrying tube 63a peels off. The second waste-toner carrying unit 65 may have the carrying auger 63b.

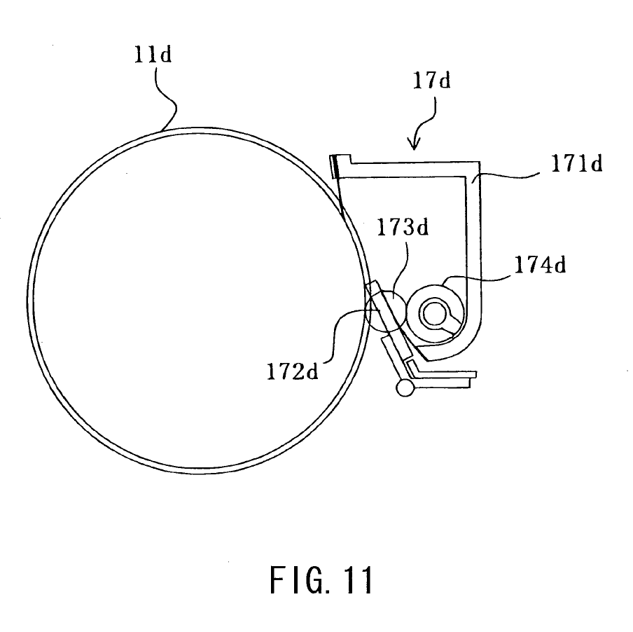

FIG. 11 is a schematic diagram of a cleaner and a photoconductive drum. Referring to the figure, the cleaner 17d includes a cleaner case 171d, a cleaning blade 172d, a cleaning brush 173d, and a carrying auger 174d. The cleaner case 171d has a discharge port. The discharge port communicates with the first waste-toner carrying unit 63. The cleaning blade 172d is set in contact with the photoconductive drum 11d and scrapes off a residual toner adhering to the photoconductive drum 11d. The cleaning blade 172d may be urethane rubber. The cleaning brush 173d is set in contact with the photoconductive drum 11d and removes sheet pieces and foreign matters adhering to the photoconductive drum 11d.

The carrying auger 174d carries the residual toner, which is scraped off from the photoconductive drum 11d by the cleaning blade 172d, to the discharge port of the cleaner case 171d as a waste toner. The carrying auger 174d is the same as the carrying auger 63b. The carrying auger 174d includes the same liner member 63c. The linear member 63c of the carrying auger 174d is set in contact with the inner surface of the cleaner case 171d. When the carrying auger 174d rotates, the linear member 63c rotates while being set in contact with the inner surface of the cleaner case 171d. The waste toner adhering to the inner surface of the cleaner case 171d peels off.

What is claimed is:

1. An image forming apparatus comprising:
an image forming unit configured to form a toner image on a sheet and configured to discharge a waste toner;
a rotating member configured to heat the toner image on the sheet;
a heater configured to heat the rotating member;
a power controller configured to maintain temperature of the rotating member in a first mode after the temperature reaches a target temperature, and configured to raise the temperature to the target temperature in a second mode after the temperature falls under the target temperature;
a waste toner container configured to store the waste toner;
an agitator configured to agitate the waste toner in the waste toner container;
an driver configured to rotate the agitator a number of times in a drive if the heat controller stops to raise the temperature in the second mode;
a counter configured to count a number of the drives; and
an agitation controller configured to set the number of times in the drive based on the number of the drives.

2. The apparatus according to claim 1, wherein the counter counts the drive if power consumption of the power controller falls from a use level to a sleep mode level.

3. The apparatus according to claim 2, wherein the agitation controller sets the number of times in the drive as a first number if the number of the drives is smaller than a threshold and the agitation controller sets the number of times in the drive as a second number smaller than the first number if the number of drives is larger than the threshold.

4. The apparatus according to claim 3, wherein the agitation controller selectively sets the number of times in the drive as the first number and the second number.

5. The apparatus according to claim 1, further comprising a cover configured to move to open and to close in order to remove a sheet jam, wherein
the counter counts the drive if the cover moves.

6. The apparatus according to claim 5, wherein the agitation controller sets the number of times in the drive as a first number if the number of the drives is smaller than a threshold and the agitation controller sets the number of times in the drive as a second number smaller than the first number if the number of drives is larger than the threshold.

7. The apparatus according to claim 6, wherein the agitation controller selectively sets the number of times in the drive as the first number and the second number.

8. The apparatus according to claim 1, wherein the second number is zero.

9. The apparatus according to claim 1, further comprising a waste-toner-amount acquiring unit configured to acquire information indicating an amount of the waste toner in the waste toner container.

10. The apparatus according to claim 9, wherein the agitator carries the waste toner to an acquisition area where the waste-toner-amount acquiring unit acquires the information indicating the amount of the waste toner.

11. A method of controlling an agitator, comprising:
maintaining temperature of a rotating member in a first mode after the temperature reaches a target temperature;
forming a toner image on a sheet;
discharging a waste toner to a waste toner container;
heating a rotating member to heat the toner image on the sheet;
raising the temperature to the target temperature in a second mode after the temperature falls under the target temperature;
rotating an agitator in the waste toner container a number of times in a drive upon interruption of the raising;
counting a number of the drives; and
setting the number of times in a following drive based on the number of the drives.

12. The method according to claim 11, wherein a number of the drives is counted if power consumption in heating falls from a use level to a sleep mode level.

13. The method according to claim 12, wherein the number of times in the following drive is set as a first number if the number of the drives is smaller than a threshold and the number of times in the following drive is set as a second number smaller than the first number if the number of drives is larger than the threshold.

14. The method according to claim 13, the number of times in the following drive is set as the first number and the second number, selectively.

15. The method according to claim 11, wherein a number of the drives is counted if a cover configured to move to open and to close in order to remove a sheet jam moves.

16. The method according to claim 15, wherein the number of times in the following drive is set as a first number if the number of the drives is smaller than a threshold and the number of times in the following drive is set as a second number smaller than the first number if the number of drives is larger than the threshold.

17. The method according to claim 16, the number of times in the following drive is set as the first number and the second number, selectively.

18. The method according to claim 11, wherein the second number is zero.

19. The method according to claim 11, further comprising:
acquiring information indicating an amount of the waste toner in the waste toner container.

20. The method according to claim 19, wherein the information
is acquired at an acquisition area where the agitator carries the waste toner.
